(19) United States
(12) Patent Application Publication
(10) Pub. No.: US 2025/0273952 A1
(43) Pub. Date: Aug. 28, 2025

(54) TRANSMISSION INTERFACE CIRCUIT AND METHOD FOR PERFORMING OVER-VOLTAGE PROTECTION IN TRANSMISSION INTERFACE CIRCUIT

(71) Applicant: Realtek Semiconductor Corp., HsinChu (TW)

(72) Inventor: Ya-Hsuan Sung, HsinChu (TW)

(73) Assignee: Realtek Semiconductor Corp., HsinChu (TW)

(21) Appl. No.: 19/055,482

(22) Filed: Feb. 17, 2025

(30) Foreign Application Priority Data
Feb. 26, 2024 (TW) 113106812

(51) Int. Cl. H02H 9/04

(52) U.S. Cl. CPC H02H 9/045

(57) ABSTRACT

A transmission interface circuit and a method for performing over-voltage protection in a transmission interface circuit are provided. The transmission interface includes a load resistor, a bias voltage source, a detection terminal and an over-voltage protection circuit, wherein the bias voltage source is coupled to a first terminal of the load resistor, the detection terminal is coupled to a second terminal of the load resistor, and the over-voltage protection circuit is coupled to the bias voltage source and the detection terminal. The bias voltage source is configured to provide a bias voltage, the detection terminal is configured to generate a detection voltage according to the load resistor, and the over-voltage protection circuit is configured to enable a discharge path when the detection voltage is greater than the bias voltage.

### BACKGROUND OF THE INVENTION

### 1. field of the Invention

The present invention is related to connecting equipment of electronic devices, and more particularly, to a transmission interface circuit and a method for performing over-voltage protection in a transmission interface circuit.

### 2. Description of the Prior Art

Related art transmission interfaces typically utilize a specific detection pin to detect a voltage generated by resistive voltage division, in order to determine a connection configuration of the transmission interface. The transmission interfaces also configure various power source pins to provide specific powers. When pins having different purposes are arranged in adjacent positions, these pins may be temporarily shorted due to various factors (e.g. the device encounters water, a connector therein is tilted, the device contacts a foreign body), resulting in a current of the pin for providing power flowing to the detection pin.

In order to prevent the short circuit issue mentioned above from causing damage to other internal circuits, related art methods provide a safety switch on a short circuit path to disconnect this path when a short circuit is detected. A disadvantage of this method is that it interrupts the transmission operation of the transmission interface. Thus, there is a need for a novel method and associated architecture, which can provide a proper over-voltage protection mechanism without significantly affecting operation of the transmission interface.

### SUMMARY OF THE INVENTION

An objective of the present invention is to provide a transmission interface circuit and a method for performing over-voltage protection in a transmission interface circuit, in order to prevent internal circuits within the transmission interface from being damaged due to a short circuit of a pin therein without introducing any side effect or in a way that is less likely to introduce side effects.

At least one embodiment of the present invention provides a transmission interface circuit. The transmission interface circuit comprises: a load resistor, a bias voltage source, a detection terminal and an over-voltage protection circuit, where the bias voltage source is coupled to a first terminal of the load resistor, the detection terminal is coupled to a second terminal of the load resistor, and the over-voltage protection circuit is coupled to the bias voltage source and the detection terminal. More particularly, the bias voltage source is configured to provide a bias voltage. The detection terminal is configured to generate a detection voltage according to the load resistor. The over-voltage protection circuit is configured to enable a discharge path when the detection voltage is greater than the bias voltage.

At least one embodiment of the present invention provides a method for performing over-voltage protection in a transmission interface circuit. The method comprises: utilizing a bias voltage source to provide a bias voltage; utilizing a detection terminal to generate a detection voltage according to a load resistor, wherein the load resistor is coupled between the bias voltage source and the detection terminal; and utilizing an over-voltage protection circuit to enable a discharge path in response to the detection voltage being greater than the bias voltage.

The transmission interface circuit and the method provided by the embodiments of the present invention can detect a short circuit of a pin by comparing the detection voltage and the bias voltage, and accordingly provide a discharge path to prevent the internal circuit from being damaged by large currents caused by the short circuit. In addition, the embodiments of the present invention do not cut off connection of the load resistor, which prevents the transmission operation of the transmission interface circuit from being interrupted. Thus, the present invention can provide a proper over-voltage protection mechanism without greatly affecting operations of the transmission interface circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating operations of a transmission interface circuit at a host side in response to a short circuit of a pin according to an embodiment of the present invention.

FIG. 2 is a diagram illustrating operations of the transmission interface circuit shown in FIG. 1 when the short circuit condition is cleared according to an embodiment of the present invention.

FIG. 3 is a diagram illustrating an over-voltage protection circuit according to an embodiment of the present invention.

FIG. 4 is a diagram illustrating a working flow of a method for performing over-voltage protection in a transmission interface circuit according to an embodiment of the present invention.

### DETAILED DESCRIPTION

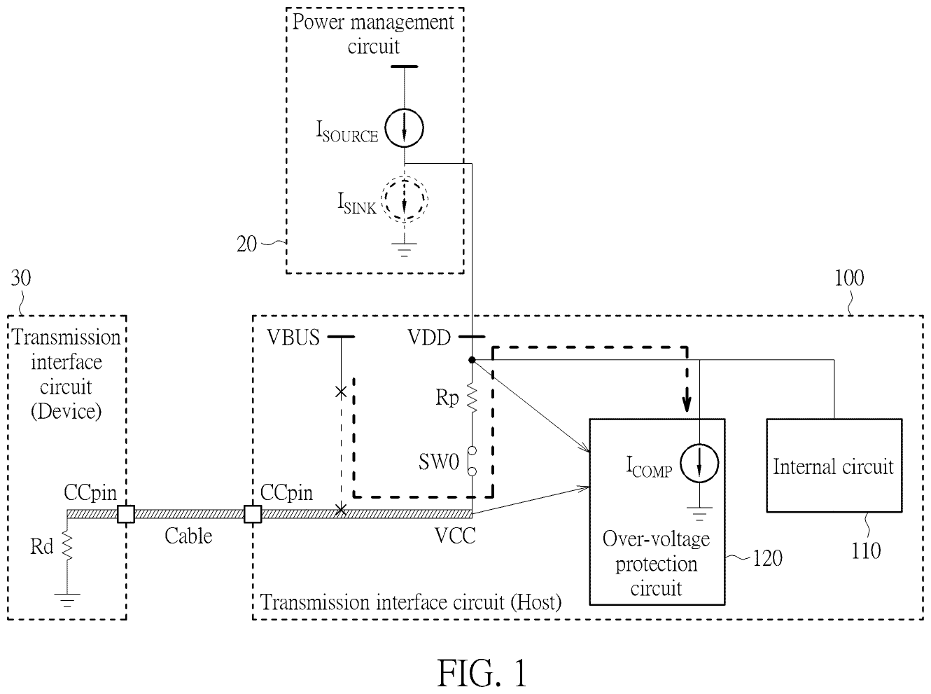

FIG. 1 is a diagram illustrating operations of a transmission interface circuit 100 at a host side (labeled “Transmission interface circuit (Host)” in figures for brevity) in response to a short circuit of a pin according to an embodiment of the present invention. In this embodiment, the transmission interface circuit 100 may be connected to a transmission interface circuit 30 at a device side via a cable (e.g. a universal serial bus (USB) type-C cable), where the transmission interface circuit 100 may be a transmission interface circuit (e.g. a USB type-C interface circuit) of a desktop computer or a laptop computer, and the transmission interface circuit 30 may be a transmission interface circuit (e.g. a USB type-C interface circuit) of a mobile device such as a smart phone, but the present invention is not limited thereto.

As shown in FIG. 1, the transmission interface circuit 30 and the transmission interface circuit 100 may each comprise a detection terminal such as a configuration channel (CC) pin CCpin, where the CC pin CCpin of the transmission interface circuit 30 and the CC pin CCpin of the transmission interface circuit 100 may be connected to each other. More particularly, the transmission interface circuit 30 may comprise a load resistor Rd coupled to the CC pin CCpin, and the transmission interface circuit 100 may comprise a load resistor Rp which is coupled to the CC pin CCpin via a switch SW0. In this embodiment, the transmission interface circuit 100 may further comprise a bias voltage source, where the bias voltage source is coupled to a first terminal of the load resistor Rp, and is configured to provide a bias voltage VDD. For brevity, the bias voltage source is illustrated by a thick line labeled “VDD” in the figures. In addition, the CC pin CCpin of the transmission interface circuit 100 is coupled to a second terminal of the load resistor Rp via the switch SW0, and is configured to generate a detection voltage VCC according to the load resistor Rp (e.g. according to resistive voltage division of the load resistor Rp within the transmission interface circuit 100 and the load resistor Rd within the transmission interface circuit 30), where the transmission interface circuit 100 may determine a role of the transmission interface circuit 100 in a communication protocol according to the detection voltage VCC. In addition, the transmission interface circuit 100 may further comprise an over-voltage protection circuit 120, where the over-voltage protection circuit 120 is coupled to the bias voltage source and the CC pin CCpin, and is configured to enable a discharge path when the detection voltage VCC is greater than the bias voltage VDD.

In this embodiment, the transmission interface circuit 100 may further comprise a bus power source terminal such as a bus power source pin VBUS, where the bus power source pin VBUS is configured to provide a bus power source (e.g. a bus current). In the pin configuration of a USB type-C interface circuit, the bus power source pin VBUS and the CC pin CCpin are adjacent pins, and therefore a temporary short circuit may occur in the bus power source pin VBUS and the CC pin CCpin due to factors such as a device encountering water, a connector therein being tilted or the device contacting a foreign body. More particularly, a voltage of the bus power source pin VBUS is typically higher than the bias voltage VDD (e.g. VBUS=5 volts and VDD=3.3 volts). Thus, when the short circuit mentioned above occurs, a pour back current flowing from the bus power source pin VBUS to the bias voltage source via the load resistor Rp may be generated, which raises the bias voltage, thereby affecting operations of an internal circuit 110 or even damaging the internal circuit 110. Even though a power management circuit 20 coupled to the bias voltage source is typically equipped with good current output capability (e.g. having a sufficient source current I_{SOURCE}), the power management circuit 20 may lack good current extraction capability (e.g. a sink current I_{SINK} may be insufficient). Thus, the power management circuit 20 is unable to effectively avoid the impact of the pour back current to the internal circuit 110 caused by the short circuit mentioned above.

In some embodiments, the transmission interface circuit 100 may turn off the switch SW0 in response to the short circuit mentioned above, in order to prevent the pour back current from being generated. Tuning off the switch SW0 may make communication between the transmission interface circuits 100 and 30 be interrupted, however. Thus, the present invention utilizes the over-voltage protection circuit 120 to provide a compensation current I_{COMP} which extracts the pour current mentioned above from the bias voltage source, thereby preventing the internal circuit 110 from being damaged by the pour back current. In particular, when the bus power source pin VBUS and the CC pin CCpin are shorted to make the detection voltage VCC be pulled up to a level greater than the bias voltage VDD (which means a current on the load resistor RP flowing from the second terminal of the load resistor Rp to the first terminal of the load resistor Rp is detected), the over-voltage protection circuit 120 may enable the discharge path (e.g. a path providing the compensation current I_{COMP}) to release the bus current from the bus power source terminal VBUS, thereby preventing the bias voltage VDD from being significantly raised.

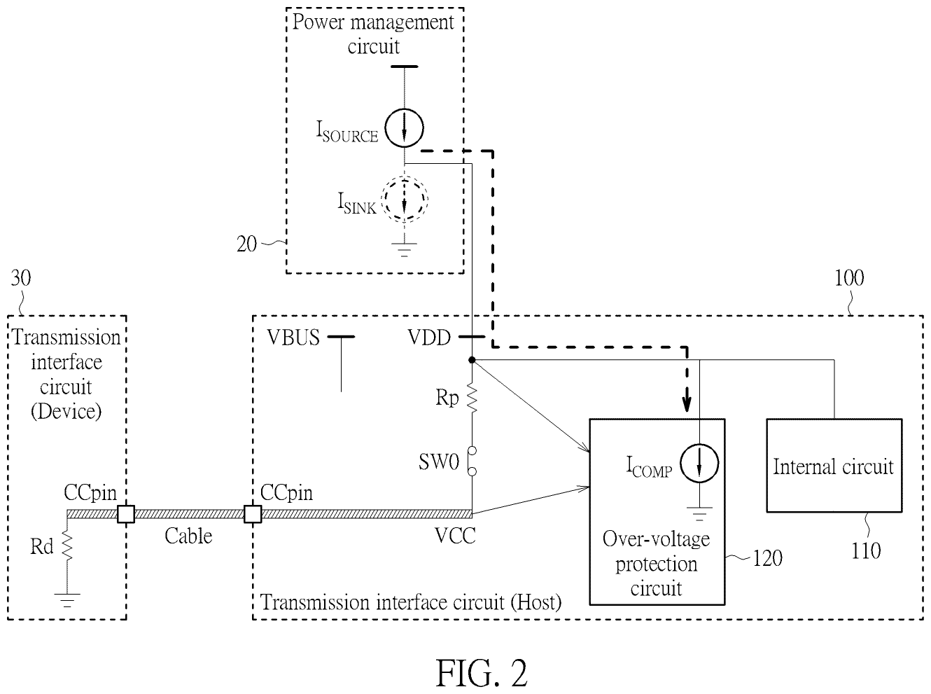

FIG. 2 is a diagram illustrating operations of the transmission interface circuit 100 shown in FIG. 1 when the short circuit condition is cleared according to an embodiment of the present invention. The short circuit condition mentioned above may be temporary, where at a moment of being cleared, the discharge path provided by the over-voltage protection circuit 120 (e.g. the path providing the compensation current I_{COMP}) may turn to extract the current of the power management circuit 20 (e.g. the source current I_{SOURCE}). As mentioned above, the power management circuit 20 is typically equipped with good current output capability (e.g. a sufficient source current I_{SOURCE}), and therefore the level of the bias voltage VDD can still be maintained at a proper level. In addition, when the over-voltage protection circuit 120 detects that the detection voltage VCC is not greater than the bias voltage VDD (i.e. detecting that the short circuit condition is cleared), the over-voltage protection circuit 120 may turn off the path of the compensation current I_{COMP} to stop extracting the currents from the bias voltage source, in order to achieve the purpose of saving power, but the present invention is not limited thereto. It should be noted that, at the moment of clearing the short circuit condition, the detection voltage VCC may recover to a level corresponding to resistive voltage division based on the load resistors Rp and Rd, thereby maintaining the correct communication protocol.

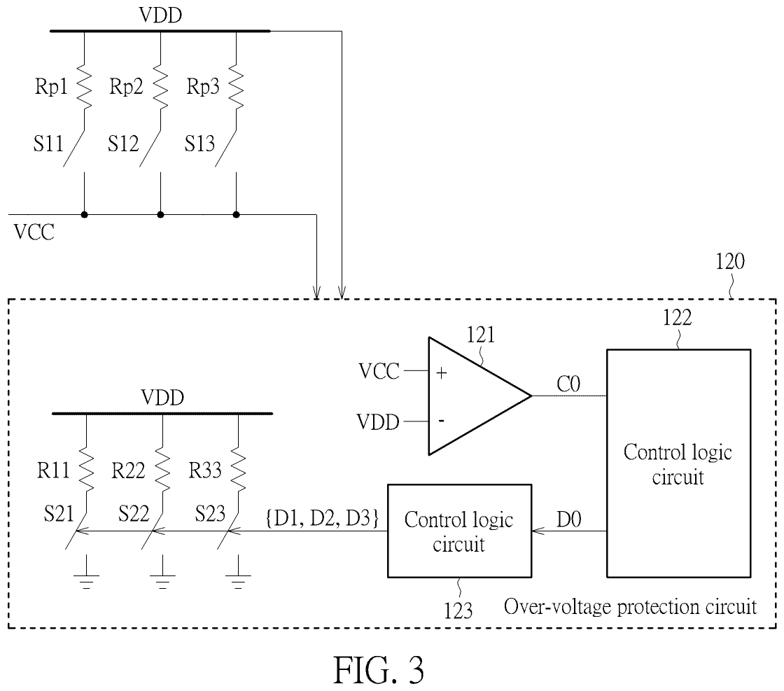

FIG. 3 is a diagram illustrating an over-voltage protection circuit 120 according to an embodiment of the present invention. It should be noted that the bus power source pin VBUS has multiple candidate bus power sources (e.g. multiple candidate bus currents), where an electronic device comprising the transmission interface circuit 100 may select one of the multiple candidate bus power sources to be the bus power source (e.g. the bus current) output from the bus power source pin VBUS. In this embodiment, the over-voltage protection circuit 120 may select one of multiple candidate discharge paths to be the discharge path according to the bus power source selected from the multiple candidate bus power sources. In addition, the multiple candidate discharge paths may respectively comprise multiple candidate discharge resistors, and the over-voltage protection circuit 120 may select a discharge resistor from the multiple candidate discharge resistors according to the bus power source selected from the multiple candidate bus power sources, in order to couple the discharge resistor between the bias voltage source and a ground voltage source. In addition, the load resistor Rp shown in FIG. 1 and FIG. 2 may be one of resistors Rp1, Rp2 and Rp3 shown in FIG. 3, and the switch SW0 shown in FIG. 1 and FIG. 2 may be one of switches S11, S12 and S13 shown in FIG. 3.

As shown in FIG. 3, the over-voltage protection circuit 120 may comprise a comparator 121 and at least one control logic circuit such as control logic circuits 122 and 123, where the control logic circuit 122 is coupled to the comparator 121, and the control log circuit 123 is coupled to the control logic circuit 122. In some embodiments, the control logic circuits 122 and 123 may be integrated in a same control logic circuit. In this embodiment, the comparator 121 is configured to compare the detection voltage VCC and the bias voltage VDD to generate a comparison result C0, and the control logic circuits 122 and 123 are configured to control whether to enable the discharge path according to the comparison result C0. In this embodiment, the over-voltage protection circuit 120 may comprise at least one discharge resistor (e.g. resistors R11, R22 and R33) and at least one control switch (e.g. switches S21, S22 and S23), where the discharge resistor R11 and the switch S21 are coupled in series between the bias voltage source and the ground voltage source, the discharge resistor R22 and the switch S22 are coupled in series between the bias voltage source and the ground voltage source, and the discharge resistor R33 and the switch S23 are coupled in series between the bias voltage source and the ground voltage source. The control logic circuit 122 may generate a control signal D0 according to the comparison result C0, to control whether to make the at least one control switch conductive. For example, the control logic circuit 123 may output control signals D1, D2 and D3 according to the control signal D0, where the switch S21 is controlled by the control signal D1, the switch S22 is controlled by the control signal D2, and the switch S23 is controlled by the control signal D3. In this embodiment, the discharge resistor R11 and the switch S21 may be taken as a first discharge path, the discharge resistor R22 and the switch S22 may be taken as a second discharge path, and the discharge resistor R33 and the switch S23 may be taken as a third discharge path.

Under a first setting, the bus current output from the bus power source pin VBUS is a first bus current, and the load resistor Rp1 may be coupled between the bias voltage source and the CC pin CCpin (e.g. by turning on the switch S11 and turning off the switches S12 and S13), where when the comparison result C0 indicates that the detection voltage VCC is greater than the bias voltage VDD, the control logic circuit 122 may output the control signal D0 to make the control logic circuit 123 utilize corresponding control signals {D1, D2, D3} (e.g. {D1, D2, D3}={1, 0, 0}) to enable the first discharge path (e.g. by turning on the switch S21 and turning off the switches S22 and S23). Under a second setting, the bus current output from the bus power source pin VBUS is a second bus current, and the load resistor Rp2 may be coupled between the bias voltage source and the CC pin CCpin (e.g. by turning on the switch S12 and turning off the switches S11 and S13), where when the comparison result C0 indicates that the detection voltage VCC is greater than the bias voltage VDD, the control logic circuit 122 may output the control signal D0 to make the control logic circuit 123 utilize corresponding control signals {D1, D2, D3} (e.g. {D1, D2, D3}={0, 1, 0}) to enable the second discharge path (e.g. by turning on the switch S22 and turning off the switches S21 and S23). Under a third setting, the bus current output from the bus power source pin VBUS is a third bus current, and the load resistor Rp3 may be coupled between the bias voltage source and the CC pin CCpin (e.g. by turning on the switch S13 and turning off the switches S11 and S12), where when the comparison result C0 indicates that the detection voltage VCC is greater than the bias voltage VDD, the control logic circuit 122 may output the control signal D0 to make the control logic circuit 123 utilize corresponding control signals {D1, D2, D3} (e.g. {D1, D2, D3}={0, 0, 1}) to enable the third discharge path (e.g. by turning on the switch S23 and turning off the switches S21 and S22).

In some embodiments, the control logic circuit 122 may perform debounce control on the comparison result C0. For example, when the comparison result indicates that the detection voltage VCC is greater than the bias voltage in one cycle only and does not indicate that the detection voltage VCC is greater than the bias voltage in the remaining cycles, the control signal D0 output from the control logic circuit 122 may be a first logic value (e.g. a logic value “0”) to prevent the control logic circuit 122 from enabling any discharge path. When the comparison result C0 indicates that the detection voltage VCC is greater than the bias voltage in multiple consecutive cycles, the control signal D0 output from the control logic circuit 122 may be a second logic value (e.g. a logic value “1”) to make the control logic circuit 123 enable the discharge path (e.g. one of the first discharge path, the second discharge path and the third discharge path).

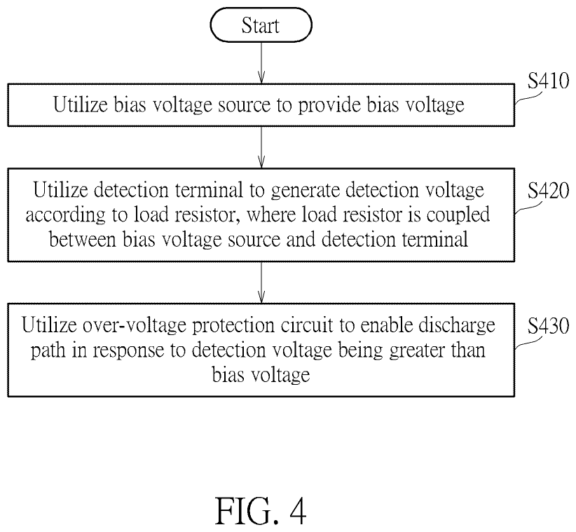

FIG. 4 is a diagram illustrating a working flow of a method for performing over-voltage protection in a transmission interface circuit (e.g. the transmission interface circuit 100 shown in FIG. 1) according to an embodiment of the present invention. It should be noted that the working flow shown in FIG. 4 is for illustrative purposes only, and is not meant to be a limitation of the present invention. For example, one or more steps may be added, deleted or modified in the working flow shown in FIG. 4. In addition, if an overall result is not affected, these steps do not have to be executed in the exact order shown in FIG. 4.

In Step S410, the transmission interface circuit may utilize a bias voltage source therein to provide a bias voltage.

In Step S420, the transmission interface circuit may utilize a detection terminal therein to generate a detection voltage according to a load resistor, where the load resistor is coupled between the bias voltage source and the detection terminal.

In Step S430, the transmission interface circuit may utilize an over-voltage protection circuit therein to enable a discharge path in response to the detection voltage being greater than the bias voltage.

To summarize, the transmission interface circuit and the method provided by the embodiments of the present invention can detect a short circuit by comparing a detection voltage and a bias voltage, and accordingly provide a discharge path to prevent a large current introduced by the short circuit from causing damage to the internal circuit. In addition, the embodiments of the present invention will not cut off the connection of the load resistor, preventing the communication of the transmission interface from being interrupted. Thus, the present invention can provide a proper over-voltage protection mechanism without greatly affecting operations of the transmission interface circuit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transmission interface circuit, comprising:
a load resistor;
a bias voltage source, coupled to a first terminal of the load resistor, configured to provide a bias voltage;
a detection terminal, coupled to a second terminal of the load resistor, configured to generate a detection voltage according to the load resistor;
an over-voltage protection circuit, coupled to the bias voltage source and the detection terminal, configured to enable a discharge path when the detection voltage is greater than the bias voltage.

2. The transmission interface circuit of claim 1, further comprising:
a bus power source terminal, configured to provide a bus power source;
wherein when the bus power source terminal and the detection terminal are shorted to make the detection voltage be pulled up to a level greater than the bias voltage, the over-voltage protection circuit enables the discharge path to release the bus power source from the bus power source terminal

3. The transmission interface circuit of claim 2, wherein one of multiple candidate bus power sources of the bus power source terminal is selected to be the bus power source, and the over-voltage protection circuit selects one of multiple candidate discharge paths to be the discharge path according to the bus power source selected from the multiple candidate bus power sources.

4. The transmission interface circuit of claim 3, wherein the multiple candidate discharge paths respectively comprise multiple candidate discharge resistors, and the over-voltage protection circuit selects a discharge resistor from the multiple candidate discharge resistors according to the bus power source selected from the multiple candidate bus power sources, to couple the discharge resistor between the bias voltage source and a ground voltage source.

5. The transmission interface circuit of claim 1, wherein the over-voltage protection circuit comprises:
a comparator, configured to compare the detection voltage and the bias voltage to generate a comparison result; and
a control logic circuit, coupled to the comparator, configured to control whether to enable the discharge path according to the comparison result.

6. The transmission interface circuit of claim 5, wherein when the comparison result indicates that the detection voltage is greater than the bias voltage in multiple consecutive cycles, the control logic circuit enables the discharge path.

7. The transmission interface circuit of claim 5, wherein the over-voltage protection circuit comprises a discharge resistor and a control switch, the discharge resistor and the control switch are coupled in series between the bias voltage source and a ground voltage source, and the control logic circuit generates a control signal according to the comparison result, in order to control whether to make the control switch conductive.

8. The transmission interface circuit of claim 1, wherein the transmission interface is a universal serial bus (USB) type-C interface circuit, and the detection terminal is a configuration channel (CC) pin of the USB type-C.

9. A method for performing over-voltage protection in a transmission interface circuit, comprising:
utilizing a bias voltage source to provide a bias voltage;
utilizing a detection terminal to generate a detection voltage according to a load resistor, wherein the load resistor is coupled between the bias voltage source and the detection terminal; and
utilizing an over-voltage protection circuit to enable a discharge path in response to the detection voltage being greater than the bias voltage.

10. The method of claim 9, further comprising:
utilizing a bus power source terminal to provide a bus power source;
wherein an operation of utilizing the over-voltage protection circuit to enable the discharge path in response to the detection voltage being greater than the bias voltage comprises:
in response to the bus power source terminal and the detection terminal being shorted to make the detection voltage be pulled up to a level greater than the bias voltage, utilizing the over-voltage protection circuit to enable the discharge path to release the bus power source from the bus power source terminal.

11. The method of claim 10, wherein one of multiple candidate bus power sources of the bus power source terminal is selected to be the bus power source, and an operation of utilizing the over-voltage protection circuit to enable the discharge path to release the bus power source from the bus power source terminal comprises:
utilizing the over-voltage protection circuit to select one of multiple candidate discharge paths to be the discharge path according to the bus power source selected from the multiple candidate bus power sources.

12. The method of claim 11, wherein the multiple candidate discharge paths respectively comprise multiple candidate discharge resistors, and an operation of utilizing the over-voltage protection circuit to select one of multiple candidate discharge paths to be the discharge path according to the bus power source selected from the multiple candidate bus power sources comprises:
utilizing the over-voltage protection circuit to select a discharge resistor from the multiple candidate discharge resistors according to the bus power source selected from the multiple candidate bus power sources, to couple the discharge resistor between the bias voltage source and a ground voltage source.

13. The method of claim 9, wherein an operation of utilizing the over-voltage protection circuit to enable the discharge path in response to the detection voltage being greater than the bias voltage comprises:
utilizing a comparator to compare the detection voltage and the bias voltage to generate a comparison result; and
utilizing a control logic circuit to control whether to enable the discharge path according to the comparison result.

14. The method of claim 13, further comprising:
in response to the comparison result indicating that the detection voltage is greater than the bias voltage in multiple consecutive cycles, utilizing the control logic circuit to enable the discharge path.

15. The method of claim 13, wherein the over-voltage protection circuit comprises a discharge resistor and a control switch, the discharge resistor and the control switch are coupled in series between the bias voltage source and a ground voltage source, and an operation of utilizing the control logic circuit to control whether to enable the discharge path according to the comparison result comprises:
utilizing the control logic circuit to generate a control signal according to the comparison result, in order to control whether to make the control switch conductive.

16. The method of claim 9, wherein the transmission interface is a universal serial bus (USB) type-C interface circuit, and the detection terminal is a configuration channel (CC) pin of the USB type-C.
